(19) United States
(12) Patent Application Publication
(10) Pub. No.: US 2025/0166315 A1
(43) Pub. Date: May 22, 2025

(54) MIXED-REALITY DEVICE HAVING IMPROVED DARK ADAPTATION

(71) Applicant: Microsoft Technology Licensing, LLC, Redmond, WA (US)

(72) Inventors: Michaela PORUBANOVA, Seattle, WA (US); Keenan Russell MAY, Bothell, WA (US)

(73) Assignee: Microsoft Technology Licensing, LLC, Redmond, WA (US)

(21) Appl. No.: 18/516,623

(22) Filed: Nov. 21, 2023

(51) Int. Cl. G06T 19/00; G02B 27/01; G06F 3/01; G06V 10/60; G06V 40/18

(52) U.S. Cl. CPC G06T 19/006; G02B 27/0172; G06F 3/013; G06V 10/60; G06V 40/193

(57) ABSTRACT

Examples are disclosed that relate to a mixed-reality device having improved dark adaptation to see in dark ambient lighting conditions. In one example, a mixed-reality device includes an eye tracker, a near-eye display, a logic subsystem, and a storage subsystem. The eye tracker is configured to determine a position of an eye. The storage subsystem holds instructions executable by the logic subsystem to generate an image frame including a plurality of pixels, wherein each pixel has a native luminance level, map the position of the eye to the image frame, adjust luminance levels of pixels of the image frame as a function of angle relative to the position of the eye mapped to the image frame and based at least on a rod and cone anatomy of the eye to generate a luminance-adjusted image frame, and render, via the near-eye display, the luminance-adjusted image frame.

### BACKGROUND

Mixed reality is a technology that blends aspects of both augmented reality and virtual reality to create a seamless, interactive, and immersive user experience. Mixed-reality devices enable users to interact with digital and physical environments simultaneously, allowing digital objects to be integrated into the real world. Mixed-reality devices can feature a see-through display that allows users to view the real world while overlaying digital content on their field of vision. Mixed-reality devices can create 3D holographic images that appear as if they are part of the user's physical environment. This enables realistic and immersive interactions with digital objects.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to a mixed-reality device having improved dark adaptation to see in dark ambient lighting conditions compared to other mixed-reality devices. In one example, a mixed-reality device includes an eye tracker, a near-eye display, a logic subsystem, and a storage subsystem. The eye tracker is configured to determine a position of an eye. The storage subsystem holds instructions executable by the logic subsystem to generate an image frame including a plurality of pixels, wherein each pixel has a native luminance level, map the position of the eye to the image frame, adjust luminance levels of pixels of the image frame as a function of angle relative to the position of the eye mapped to the image frame and based at least on a rod and cone anatomy of the eye to generate a luminance-adjusted image frame, and render, via the near-eye display, the luminance-adjusted image frame.

### BRIEF DESCRIPTION OF THE DRAWINGS

FIG. 1 shows an example mixed-reality device worn by a user in dark ambient lighting conditions.

FIG. 2 schematically shows an example mixed-reality device.

FIG. 3 schematically shows example rod and cone anatomy of an eye.

FIG. 4 shows a graph indicating rod and cone receptor density relative to angular separation from a fovea of an eye.

FIG. 5 shows an example image frame generated by a mixed-reality device.

FIG. 6 shows an example luminance-adjusted image frame generated by a mixed-reality device.

FIGS. 7-8 show different example luminance-adjusted image frames generated by a mixed-reality device based at least on different positions of the fovea of the eye.

FIG. 9 shows example luminance-adjusted image frames displayed in a left-eye display and a right-eye display of a mixed-reality device that is operating in a monocular operating mode.

FIGS. 10-11 show an example method for controlling a mixed-reality device.

FIG. 12 shows an example computing system.

### DETAILED DESCRIPTION

A mixed-reality device displays digital content to the eyes of a user. More particularly, when light emitted from the mixed-reality device enters the eyes of the user, photoreceptor cells in the eyes convert the light into electrical signals that can be interpreted by the brain of the user as sight/vision. There are two main types of photoreceptors in the human eye: rods and cones. Rods are the photoreceptor cells that are primarily responsible for low-light or scotopic vision. Rods are highly sensitive to dim light and are crucial for night vision. Rods are concentrated in the peripheral regions of the retinas of the eyes. Cones are responsible for color vision (photopic vision) and provide the ability to see a wide range of colors and perceive fine details.

Cones are concentrated in the central part of the retina, known as the fovea, which is responsible for high acuity vision. The interplay between rods and cones allows the user to see effectively in various lighting conditions. In bright lighting conditions, cones are responsible for sharp, colorful vision, while in dim lighting conditions, rods take over to provide night vision, albeit in shades of gray. This combination of photoreceptor cells enables humans to have a versatile and functional visual system.

In some scenarios when using a mixed-reality device, a user desires to retain dark adaptation in order to see in low-light or dark ambient lighting conditions. However, a conventional mixed-reality device displays digital images in a manner that compromises user vision in low-light or dark ambient lighting conditions by de-activating rods in the eyes of the user. Thus, when using the conventional mixed-reality device in low-light or dark ambient lighting conditions (or when deactivating the display of the conventional mixed-reality device or when the conventional mixed-reality device is taken off), the eyes of the user are not dark adapted, yielding the user temporarily visually impaired in those low-light or dark ambient lighting conditions. Additionally, while wearing the conventional mixed-reality device, a user may be limited in their ability to utilize peripheral vision. For example, if the conventional mixed-reality device is an open-peripheral configuration, peripheral vision is compromised due to the rods in the eyes of the user being de-activated by the light emitted from the display of the conventional mixed-reality device.

Accordingly, examples are disclosed herein that relate to a mixed-reality device having improved dark adaptation to see in low-light or dark ambient lighting conditions by using eye tracking-based foveated luminance rendering that is based on the distribution of cones and rods in the retina and their differential role in dark adaptation. In one example, a mixed-reality device includes an eye tracker configured to determine a position of an eye. The mixed-reality device is configured to generate an image frame including a plurality of pixels, wherein each pixel has a native luminance level. As used herein, native luminance levels of the image frame refer to luminance or brightness/intensity levels of pixels in the image frame and that are generated without consideration for dark adaptation and are not adjusted for dark adaptation. The mixed-reality device is further configured to map the position of the eye to the image frame and adjust luminance levels of pixels of the image frame as a function of angle relative to the position of the eye mapped to the image frame and based at least on a rod and cone anatomy of the eye to generate a luminance-adjusted image frame. The mixed-reality device is further configured to render the luminance-adjusted image frame via a near-eye display of the mixed-reality device.

The rod and cone anatomy of the eye is arranged such that the concentration of cones is highest at and near a fovea of the eye, which is typically located at a central 2 degrees of a retina of the eye. The density of cones decreases rapidly moving away from the fovea to a constant level typically at about 10-15 degrees from the fovea. This is also where the density of rods in the eye reaches a maximum.

In one example, the mixed-reality device is configured to set luminance levels of pixels in the luminance-adjusted image frame that map to the region of the eye where the concentration of cones is highest to photopic-level luminance. This region of the luminance-adjusted image frame is referred to herein as the photopic luminance region of pixels in the luminance-adjusted image frame. In some examples, luminance levels of pixels in the photopic luminance region are set to native luminance levels of the image frame and are not reduced or dimmed for purposes of improved dark adaptation. By preserving the photopic-level luminance in the region of the luminance-adjusted image frame that maps to the region of the eye where the concentration of cones is highest, visual acuity of the user and the ability of the user to recognize vivid colors in the luminance-adjusted image frame can be preserved. In other examples, luminance levels of pixels in the photopic luminance region may be reduced relative to native luminance levels of corresponding pixels of the image frame. In one example, the luminance levels in the photopic luminance region may be globally reduced by the same offset. In this configuration, dark adaptation is prioritized over visual acuity relative to the other configuration where the luminance levels of pixels in the photopic luminance region are set to native luminance levels.

Further, the mixed-reality device is configured to adjust luminance levels of pixels in the luminance-adjusted image frame that map to the region of the eye where the concentration of rods is highest to lower than the native luminance levels of corresponding pixels of the image frame. This region of the luminance-adjusted image frame is referred to herein as the luminance roll-off region of pixels in the luminance-adjusted image frame. In one particular example, the luminance levels of the pixels in the luminance roll-off region are adjusted as a function of angle and cone density relative to the position of the fovea such that the reduction in luminance mimics the decrease in density of the cones moving away angularly from the fovea in the eye.

The mixed-reality device provides the technical feature of tracking the position of the eye via the eye-tracker and generating luminance-adjusted image frames that are updated to account for eye movement. This technical feature provides the benefit of ensuring that the same receptors in the eye are exposed to the same luminance-levels in order to preserve dark adaptation in the retinal periphery where the rod density is highest, while achieving high visual acuity in the center region of the eye where the cone density is highest. Moreover, this technical feature provides the additional benefit of reducing power consumption of the mixed-reality device relative to a conventional mixed-reality device that renders an image frame with photopic-level luminance across the entire image frame.

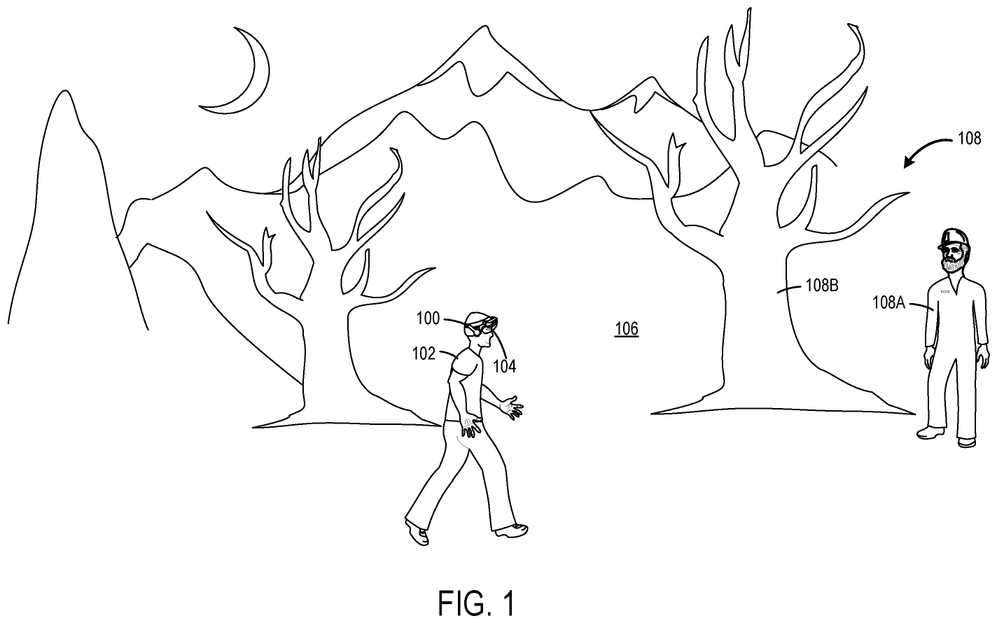

FIG. 1 shows aspects of an example mixed-reality device 100 worn by a user 102 in low-light or dark ambient lighting conditions. The mixed-reality device 100 includes a near-eye display 104 configured to visually present mixed-reality image frames of the real-world physical environment 106. The real-world physical environment 106 includes a plurality of real-world objects 108, such as a person 108A and a tree 108B that are visible to the user 102 via the near-eye display 104.

The mixed-reality image frames visually presented to the user 102 via the near-eye display 104 include digital content that appears to be integrated into the real-world physical environment 106 in an immersive manner that can respond to movements of the user 102 or other objects (real or digital) in the real-world physical environment 106.

In some examples, the digital content may appear to be body-locked, such that the digital content appears to move with a change in perspective of the user 102 as a pose (e.g., 6 degrees of freedom (DOF): x, y, z, yaw, pitch, roll) of the mixed-reality device 100 changes in the real-world physical environment 106. As such, body-locked digital content appears to occupy the same portion of a field of view of the near-eye display 104 at the same distance from the user 102, even as the user 102 moves in the real-world physical environment 106.

In other examples, the digital content appears world-locked, such that the digital content appears to remain in a fixed location in the real-world physical environment 106, even as the perspective of the user 102 and the pose of the mixed-reality device 100 changes. To support display of world-locked digital content, in one example, the mixed-reality device 100 is configured to track a 6DOF pose of the mixed-reality device 100 relative to the real-world physical environment 106 and perform geometric mapping/modeling of surface aspects of the real-world physical environment 106.

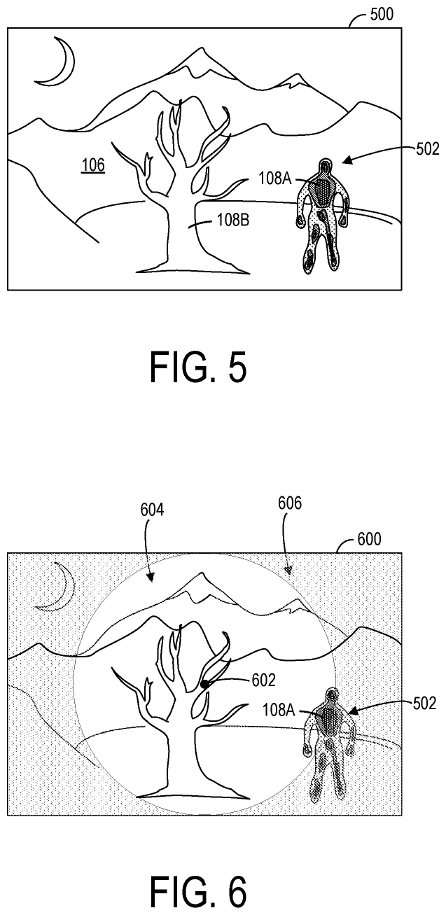

FIG. 5 shows an example mixed-reality image frame 500 of the real-world physical environment 106 generated by the mixed-reality device 100. The mixed-reality image frame 500 blends digital content with real-world content from the real-world physical environment 106. In particular, in the mixed-reality image frame 500, the person 108A is located next to the tree 108B, and the person 108A is augmented with a digital representation of a heat signature 502. For example, the digital representation of the heat signature 502 of the person 108A may allow for the user 102 (shown in FIG. 1) to identify the position of the person 108A in the real-world physical environment 106 more easily during dark ambient lighting conditions in which it would otherwise be difficult to see the person 108A if the user were viewing the real-world physical environment without using the mixed-reality device 100.

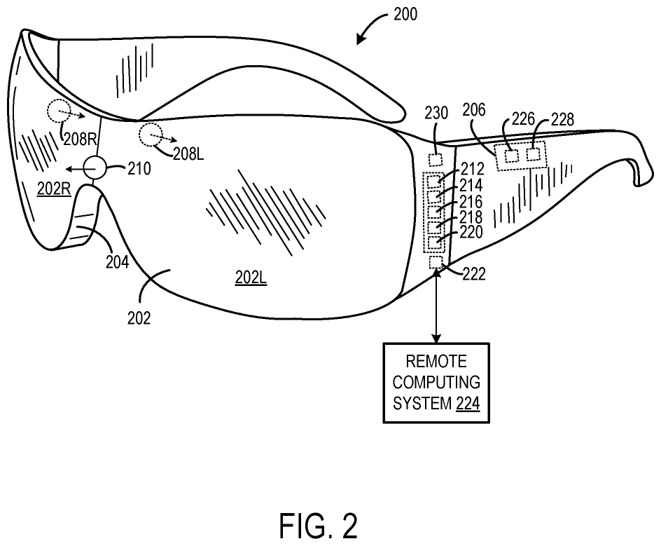

As discussed above, under low-light or dark ambient lighting conditions, a user desires to preserve dark adaptation while using the mixed-reality device 100 (and afterward). To that end, the mixed-reality device 100 is configured to determine the positions of the eyes of the user 102 via eye trackers 208L, 208R (shown in FIG. 2). The mixed-reality device 100 is configured to generate mixed-reality image frames corresponding to each of the left and right eyes of the user. Each mixed-reality image frame includes a plurality of pixels having native luminance levels. The mixed-reality device 100 is further configured to map the positions of the eyes to the respective mixed-reality image frames and adjust luminance levels of pixels of the mixed-reality image frames as a function of angle relative to the position of the corresponding eye mapped to the corresponding mixed-reality image frame and based at least on a rod and cone anatomy of the respective eye to generate luminance-adjusted image frames. The mixed-reality device 100 is further configured to render the luminance-adjusted image frames via the near-eye display 104. More particularly, each luminance-adjusted image frame includes a photopic luminance region of pixels and a luminance roll-off region of pixels. These regions are determined based at least on the position of the eye of the user. The mixed-reality device 100 sets the luminance levels of pixels in the photopic luminance region to the native luminance levels of corresponding pixels in the mixed-reality image frame and adjusts the luminance levels of pixels in the luminance roll-off region lower than the native luminance levels of corresponding pixels of the mixed-reality image frame.

By reducing luminance levels of pixels in the luminance roll-off region, the rods in the corresponding region of the eye can remain activated in order to preserve vision of the eye in the low-light or dark ambient lighting conditions. Further, by reducing luminance levels of pixels in the luminance roll-off region of the luminance-adjusted image frame, power consumed by the mixed-reality device 100 to render the luminance-adjusted image frame is reduced relative to rendering the image frame having brighter native luminance levels. Moreover, by maintaining the luminance levels in the photopic luminance region at the native luminance levels, the luminance-adjusted image frame may be perceived by the user as being just as vivid as the original mixed-reality image frame.

The mixed-reality device 100 is provided as a non-limiting example of a device having improved dark adaptation to see in low-light or dark ambient lighting conditions by using eye tracking-based foveated luminance rendering that is based on the distribution of cones and rods in the eye and their differential role in dark adaptation. These concepts are broadly applicable to other types of mixed-reality devices without departing from the scope of the present disclosure.

FIG. 2 shows aspects of an example mixed-reality device 200. More particularly, the mixed-reality device 200 takes the form of a pair of wearable glasses comprising a near-eye display 202. For example, the mixed-reality device 200 may correspond to the mixed-reality device 100 shown in FIG. 1. In other implementations, the mixed-reality device may take any other suitable form in which a transparent, semi-transparent, and/or non-transparent display is supported in front of an eye or eyes of a user and configured to perform eye tracking-based foveated luminance rendering that is based on the distribution of cones and rods in the eyes of the user in order to preserve dark adaptation to see in low-light or dark ambient lighting conditions.

The near-eye display 202 may be configured to visually augment an appearance of a real-world physical environment to a user viewing the physical environment through the near-eye display 202. The near-eye display 202 includes a left-eye display 202L and a right eye display 202R. The left-eye display 202L is configured to render luminance-adjusted mixed-reality image frames to the left eye of the user. The right-eye display 202R is configured to render luminance-adjusted mixed-reality image frames to the right eye of the user. In one example, the near-eye display 202 may be configured to display one or more digital objects in one or more luminance-adjusted mixed-reality image frames. In some cases, the digital objects may be overlaid in front of the real-world environment. Further, in some cases, the digital objects may incorporate elements of real-world objects of the real-world environment seen through the near-eye display 202.

Any suitable mechanism may be used to render luminance-adjusted mixed-reality image frames for display via the near-eye display 202. As one example, the near-eye display 202 may include image-producing elements located within lenses 204 (such as, for example, a see-through Organic Light-Emitting Diode (OLED) display). As another example, the near-eye display 202 may include a display device (such as, for example a liquid crystal on silicon (LCOS) device or OLED microdisplay) located within a frame of the mixed-reality device 200. In this example, the lenses 204 may serve as light guides for delivering light from the display device to the eyes of the user. Such light guides may enable a wearer to perceive a 3D holographic image located within the physical environment that the user is viewing, while also allowing the user to view physical objects in the physical environment. The near-eye display 202 is controlled by a controller 206 of the mixed-reality device 200 to render luminance-adjusted mixed-reality image frames for display to the user.

In other implementations, the mixed-reality device 200 may include a partially transparent display or a non-transparent display that is configured to present luminance-adjusted mixed-reality images of the real-world physical environment.

In some implementations, the mixed-reality device 200 may comprise a sensor subsystem including various sensors and related subsystems to provide information to the controller 206. Some such sensors, for example, may provide biometric data of a human subject wearing the head-mounted computing system. Other such sensors may provide environmental and/or activity data for an environment in which the user is located. Example sensors included in the sensor subsystem may include, but are not limited to, eye trackers 208L and 208R, one or more outward-facing image sensors 210, an ambient temperature sensor 212, an accelerometer 214, a gyroscope 216, a magnetometer 218, and a global positioning system (GPS) receiver 220.

The eye trackers 208L, 208R are configured to determine the positions of the eyes of the user (e.g., eye tracker 208L determines the position of the left eye and eye tracker 208R determines the position of the right eye). More particularly, the eye trackers 208L, 208R are configured to determine the positions of foveas in the eyes of the user. In some implementations, the eye trackers 208L, 208R may include image sensors configured to acquire image data of the eyes of the user in order to determine the positions of the eyes. In some implementations, the eye trackers 208L, 208R may include light sources, such as infrared light sources, that are configured to cause glints of light to reflect from the corneas of the eyes of the user. Images of the glints and of the pupils may be used to determine a direction where the eyes of the user are gazing. In some implementations, the mixed-reality device 200 may be configured to recognize a real-world physical object and/or a virtual object at which the eyes of the user are gazing.

In some implementations, the mixed-reality device 200 may be configured to determine, via the eye trackers 208L, 208R, an eye relief distance between the position of the eyes of the user and the near-eye display 204. The mixed-reality device 200 may be configured to use the determined eye relief distance to accurately map the position of the eyes of the user to image frames generated by the mixed-reality device 200 to perform accurate foveated luminance rendering for improved dark adaptation.

In some implementations, the eye trackers 208L, 208R may be configured to determine various other features/parameters of the eyes of the user, such as pupil dilation and blood vessel size, that may be used to accurately map the position of the eyes of the user to image frames generated by the mixed-reality device 200.

The eye tracker(s) of the mixed-reality device 200 can include any suitable device that is configured to determine a position of an eye of the user.

The one or more outward-facing image sensors 210 may be configured to receive environmental data from the physical environment in which the mixed-reality device 200 is located. The one or more outward-facing image sensors 210 may include a visible light sensor, an ultraviolet light sensor, an infrared (IR) light sensor, a thermal sensor, a depth sensor (e.g., time-of-flight, structured light, or other suitable depth sensing system, such as a stereo camera system), and other suitable image sensors.

In some implementations, the image sensor(s) 210 may include an ambient light sensor configured to determine an ambient luminance level of the real-world physical environment.

In some implementations, the mixed-reality device 200 may be configured to use image data from the outward-facing image sensor(s) 210 to detect movements, such as gesture-based inputs or other movements performed by the user or by another person or physical object in the surrounding real-world physical environment. In some implementations, the mixed-reality device 200 may be configured to use image data from the outward-facing image sensor(s) 210 to recognize/identify object in the real-world physical environment.

In some implementations, the mixed-reality device 200 may be configured to use the image data from the outward-facing image sensor(s) 210 to determine direction/location and orientation data that enables position/motion tracking of the mixed-reality device 200 in the real-world physical environment. In some examples, the mixed-reality device 200 may be configured to use image data from the outward-facing image sensors 210 to perform simultaneous localization and mapping (SLAM) to create and update maps of the real-world physical environment while simultaneously tracking the location of the mixed-reality device 200 within that environment.

In some implementations, the mixed-reality device 200 may be configured to use image data from the outward-facing image sensor(s) to determine ambient temperature conditions of the real-world physical environment (including other human subjects and other suitable sources of temperature variation). For example, temperature may be inferred from long wave IR camera data. In some implementations, the mixed-reality device 200 may be configured to generate mixed-reality images in which real-world objects in the real-world physical environment are augmented with digital representations of heat signatures of the objects.

The ambient temperature sensor 212 may be configured to provide a measurement of the ambient temperature of the real-world physical environment. The temperature sensor 212 may employ any suitable temperature sensing technology. The mixed-reality device 200 may be configured to use the temperature measured by the temperature sensor 212 to generate the digital representations of the heat signatures of the objects in the real-world physical environment and/or perform calibration of the heat signatures.

The mixed-reality device 200 may also include motion sensing componentry, such as the accelerometer 214, the gyroscope 216, and/or the magnetometer 218. The accelerometer 214 and gyroscope 216 may furnish inertial data along three orthogonal axes as well as rotational data about the three axes, for a combined six degrees of freedom. Data from the accelerometer 214 and gyroscope 216 may be combined with geomagnetic data from the magnetometer 218 to further define the inertial and rotational data in terms of geographic orientation. In some implementations, data from the outward-facing image sensor(s) 210 and the notion sensing componentry may be used in conjunction to determine a position and orientation of the mixed-reality device 200.

The GPS receiver 220 may be configured to determine the geographic location and/or velocity of the mixed-reality device 200. In some implementations, data from the GPS receiver 220 may be used in conjunction with data from the motion sensing componentry to determine the position, orientation, velocity, acceleration, and other suitable motion parameters of the mixed-reality device 200.

In some implementations, the mixed-reality device 200 may include a communication subsystem 222 comprising suitable wired or wireless communications I/O interface componentry. The communication subsystem 222 may be configured to enable the mixed-reality device 200 to communicate with other remote computing systems, such as the remote computing system 224. For example, the communication subsystem 222 may include, but is not limited to, USB, two-way Bluetooth, Bluetooth Low Energy, Wi-Fi, cellular, Ethernet, near-field communication, and/or other suitable communication componentry. In some implementations, the communication suite may include an additional transceiver for optical, line-of-sight (e.g., infrared) communication. In some implementations, communication with the remote computing system 224 may allow the mixed-reality device 200 to receive various information that informs the eye tracking-based foveated luminance rendering process described herein.

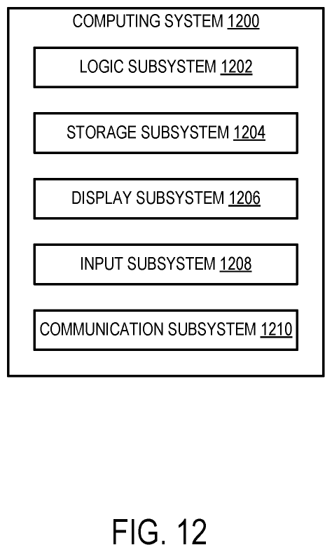

The controller 206 includes a logic subsystem 226 and a storage subsystem 228, discussed in more detail below with respect to FIG. 12. The storage subsystem 228 holds instructions executable by the logic subsystem 226 to provide various functionality of the mixed-reality device 200. For example, as described above, the mixed-reality device 200 may be configured to perform eye tracking-based foveated luminance rendering that is based at least on the distribution of cones and rods in the eyes of the user in order to preserve dark adaptation to see in low-light or dark ambient lighting conditions. One example of eye tracking-based foveated luminance rendering for a single eye is discussed herein. Note that, in some implementations, the mixed-reality device may be configured to perform the same or similar functionality individually for both eyes of the user. In particular, the storage subsystem 228 holds instructions executable by the logic subsystem 226 to determine the position of the eye via the eye tracker 208L/208R. More particularly, the eye tracker 208L/208R may be configured to determine the position of the fovea of the eye.

The storage subsystem 228 holds instructions executable by the logic subsystem 226 to generate an image frame including a plurality of pixels. Each pixel of the image frame has a native luminance level. The image frame may include digital objects that interact with real-world objects in the real-world physical environment to create a mixed-reality experience for the user.

The storage subsystem 228 holds instructions executable by the logic subsystem 226 to map the position of the eye to the image frame. In one example, the mapping process includes determining a location in the image frame that aligns with the determined position of the fovea of the eye. Such mapping allows for the digital content displayed on the near-eye display 202 to align correctly with the user's perspective and gaze in order to create a seamless and immersive mixed-reality experience. In some implementations where an eye relief distance between the position of the eye and the near-eye display 202 is determined via the eye tracker 208L/208R, the position of the eye may be mapped to the image frame based at least on the eye relief distance. For example, as the eye relief distance from the near-eye display increases, the portion of the image frame that is covered by the eye decreases and vice versa.

The storage subsystem 228 holds instructions executable by the logic subsystem 226 to adjust luminance levels of pixels of the image frame as a function of angle relative to the position of the eye mapped to the image frame and based at least on a rod and cone anatomy of the eye to generate a luminance-adjusted image frame.

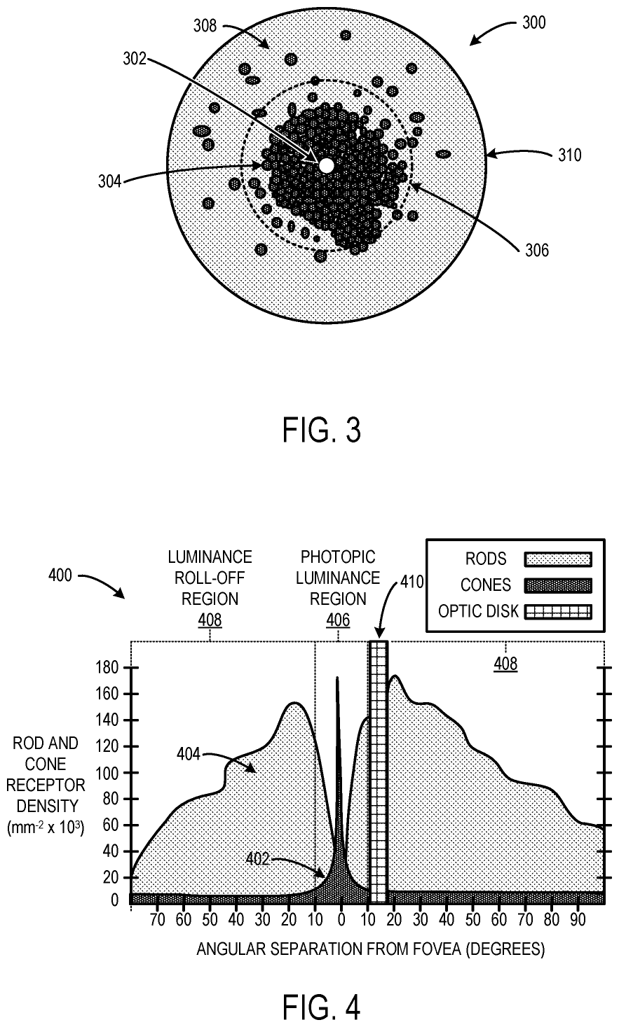

FIG. 3 schematically shows example rod and cone anatomy of an eye 300. The eye 300 includes a fovea 302 positioned centrally in the eye 300. A plurality of cones 304 are concentrated around the fovea 302 in a central region 306 and decrease rapidly moving angularly away from the fovea 302. On the other hand, a plurality of rods 308 are concentrated in a peripheral region 310 of the eye 300. As the eye 300 moves to gaze in different directions or assume different perspectives the positions of the positions of the rods and cones change relative to the image frame for purposes of mapping.

FIG. 4 shows a graph 400 indicating example rod and cone receptor density relative to angular separation from the fovea of the eye. In the graph 400, a cone density 402 peaks at zero degrees on the X-axis of the graph 400, which corresponds to the position of the fovea. The cone density 402 decreases rapidly moving angularly away from the position of the fovea to a constant level at about 10-15 degrees from the fovea. Further, the rod density peaks at approximately 20 degrees on the X-axis of the graph 400, which approximately corresponds to the point where the cone density 402 reaches a constant density. The rod density 404 decreases non-linearly moving angularly away from the fovea as indicated by the slope of the rod density 404 shown in the graph 400.

In some implementations, the storage subsystem 228 holds instructions executable by the logic subsystem 226 to adjust the luminance levels of the pixels of the image frame as a function of angle relative to the position of the fovea of the eye mapped to the image frame and based at least on the rod and cone anatomy of the eye to generate the luminance-adjusted image frame. More particularly, in some implementations, a photopic luminance region of pixels of the luminance-adjusted image frame and a luminance roll-off region of pixels of the luminance-adjusted image frame are determined based at least on the position of the fovea of the eye. As shown in FIG. 4, the photopic luminance region 406 is centered around the fovea at zero degrees and extends outward angularly to the angular position where the cone density 402 becomes constant (e.g., approximate at 10-15 degrees). The luminance roll-off region 408 begins at the angular boundary of the photopic luminance region 406 and extends outward angularly such that the luminance roll-off region 408 surrounds the photopic luminance region 406.

In some implementations, the storage subsystem 228 holds instructions executable by the logic subsystem 226 to set luminance levels of pixels in the photopic luminance region to the native luminance levels of corresponding pixels in the original image frame generated by the mixed-reality device 200. For example, the luminance levels of pixels in the photopic luminance region may be set to greater than 10 candelas per square meter, which is approximately equivalent to typical indoor ambient lighting conditions. Because the concentration of cones is highest around the fovea, the luminance levels of pixels in the photopic luminance region are maintained at native luminance levels in order to help improve visual acuity of the user in perceiving this region of the luminance-adjusted image.

Further, the storage subsystem 228 holds instructions executable by the logic subsystem 226 to adjust luminance levels of pixels in the luminance roll-off region lower than the native luminance levels of corresponding pixels of the image frame. In one example, the luminance levels of pixels in the luminance roll-off region are reduced as a function of angle and rod and cone density relative to the position of the fovea as mapped to the image frame. In other words, the reduction in the luminance levels of the pixels in the luminance roll-off region may mimic the drop-off in the cone density as shown in the graph 400 shown in FIG. 4, in one example. Further, the pixels that correspond to the region of the eye having a constant level of cones (e.g., beyond 20 degrees) may be reduced below a photopic threshold of approximately one candela per meter squared, which is the luminance level at which the rods in the eye become deactivated. In other examples, the luminance levels of pixels in the luminance roll-off region may be reduced differently (e.g., at different rates/slopes).

FIG. 6 shows an example luminance-adjusted image frame 600 that is generated based on the image frame 500 shown in FIG. 5. The mapped position of the fovea of the eye is indicated at 602 on the luminance-adjusted image frame 600. The photopic luminance region 604 of pixels of the luminance-adjusted image frame 600 is determined based on the mapped position of the fovea 602. More particularly, the photopic luminance region 604 of pixels is centered on the mapped position of the fovea 602 and extends an angular distance away from the mapped position of the fovea 602 corresponding to an angle where the cones in the eye fall below a threshold level (e.g., approximate 10-15 degrees). The luminance roll-off region 606 of pixels of the luminance-adjusted image frame 600 is also determined based on the mapped position of the fovea 602. More particularly, the inner boundary of the luminance roll-off region 606 of pixels corresponds with the boundary of the photopic luminance region 604 (e.g., at approximately 10-15 angular degrees away from the position of the fovea 602) and extends to the edges of the luminance-adjusted image frame 600. In this example, the luminance roll-off region 606 of pixels surrounds the photopic luminance region 604 of pixels. In the photopic luminance region 604, pixels are set to native luminance levels that are the same as corresponding pixels of the image frame 500 shown in FIG. 5. In the luminance roll-off region 606 luminance levels of pixels are adjusted lower than the native luminance levels of corresponding pixels of the image frame 500 shown in FIG. 5.

In the illustrated example, the digital representation of the heat signature 502 that is overlaid on the person 108A is positioned in both the photopic luminance region 604 and the luminance roll-off region 606 in the luminance-adjusted image frame 600. The pixels of the digital representation of the heat signature 502 that are positioned in the photopic luminance region 604 are set to native luminance levels of corresponding pixels of the image frame 500 shown in FIG. 5. The pixels of the digital representation of the heat signature 502 that are positioned in the luminance roll-off region 606 are adjusted lower than the native luminance levels of corresponding pixels of the image frame 500 shown in FIG. 5. However, the user viewing the luminance-adjusted image frame 600 may not perceive the digital representation of the heat signature 502 as being both bright and dim, because the dim portion of the digital representation of the heat signature 502 is located in the peripheral region of the field of view of the user where visual acuity is reduced relative to the central region where the fovea is located.

In some implementations, the mixed-reality device 200 may be configured to adjust the luminance levels of pixels in the luminance-adjusted image frame 600 based at least on some other parameters that indicate or infer the ambient brightness of the surrounding real-world physical environment.

In some implementations where the mixed-reality device 200 includes an ambient light sensor 210 configured to determine an ambient luminance level of a surrounding environment, the storage subsystem 228 may hold instructions executable by the logic subsystem to adjust the luminance levels of the pixels of the image frame further based at least on the ambient luminance level of the surrounding environment to generate the luminance-adjusted image frame. For example, during darker ambient lighting conditions (e.g., in the middle of the night), luminance levels of pixels in the luminance roll-off region may be reduced to a greater degree than when the ambient lighting conditions have a higher luminance level (e.g., at dusk). In another example, the luminance levels of pixels may be reduced at a higher rate or steeper roll-off when ambient lighting conditions are darker than when ambient lighting conditions are lighter. The luminance levels of the pixels of the luminance-adjusted image frame may be adjusted in any suitable manner based at least on the ambient luminance level determined by the ambient light sensor 210.

In some implementations where the mixed-reality device 200 includes the communication subsystem 222, the mixed-reality device 200 may receive a predicted ambient luminance level of the surrounding environment from the remote computing system 224. As one example, the remote computing system 224 may include a meteorological service and the predicted ambient luminance level is based on a weather forecast from the meteorological service. As another example, the remote computing system 224 may include a service that provides information about the timing of sunrise and sunset that informs a prediction of the ambient luminance level. As yet another example, the remote computing system 224 may include a map service that predicts ambient lighting conditions based on a GPS position of the mixed-reality device. For example, if the mixed-reality device 200 is located in a city, then the city lights may provide brighter ambient lighting conditions relative to if the mixed-reality device 200 being located in a forest outside of the city. The luminance levels of the pixels of the luminance-adjusted image frame may be adjusted in any suitable manner based at least on the predicted ambient luminance level received from the remote computing system 224.

The storage subsystem 228 holds instructions executable by the logic subsystem 226 to render the luminance-adjusted image frame via the near-eye display 202. The mixed-reality device 200 is configured to repeatedly generate and render updated luminance-adjusted image frames as the position of the fovea of the eye moves as tracked by the eye tracker 208L/208R. The luminance-adjusted image frames may be updated according to any suitable refresh rate. In some examples, the refresh rate may be synchronized with the refresh rate of the eye tracker 208L/208R. In other examples, the refresh rate may be synchronized with the refresh rate of the near-eye display 202. Note that, in some examples, the mixed-reality device 200 may be configured to perform same or similar functionality individually for both eyes of the user.

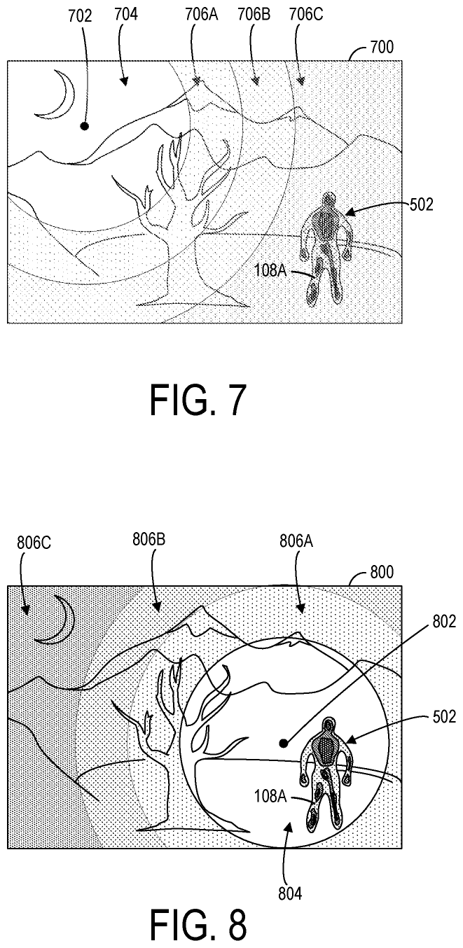

FIGS. 7-8 show different example luminance-adjusted image frames generated by a mixed-reality device based at least on different positions of the fovea of the eye. Note that as the eye moves relative to the near-eye display 202, the relative position of the rods and cones in the eye also changes relative to the near-eye display 202. FIG. 7 shows a first example luminance-adjusted image frame 700 generated from the image frame 500 shown in FIG. 5 and based at least on the fovea being in a first position 702 relative to the near-eye display 202. FIG. 8 shows a second example luminance-adjusted image frame 800 generated from the image frame 500 shown in FIG. 5 and based at least on the fovea being in a second position 802 relative to the near-eye display 202 that is different than the first position 702.

In FIG. 7, the fovea is mapped to a first position 702 in the luminance-adjusted image frame 700. The luminance-adjusted image frame 700 includes a photopic luminance region 704 that is determined based at least on the first position 702 of the fovea. Pixels in the photopic luminance region 704 are set to native luminance levels that are not dimmed. The luminance-adjusted image frame 700 includes a luminance roll-off region 706 (e.g., including circular regions 706A, 706B, 706C). Pixels in different circular regions 706A, 706B, 706C of the luminance roll-off region 706 have luminance levels that are reduced to different degrees. In this example, luminance levels of pixels in the first circular region 706A are adjusted lower than luminance levels of pixels in the photopic luminance region 704, luminance levels of pixels in the second circular region 706B are adjusted lower than luminance levels of pixels in the first circular region 706A, and so on.

Note that the different circular regions 706A, 706B, 706C of the luminance roll-off region 706 are presented for ease of understanding. In general, as the angular distance from the first position 702 of the fovea increases, the luminance levels of pixels are reduced to a greater degree until such luminance levels are reduced below a photopic threshold. In some examples, the roll-off can be a gradient that varies smoothly. The roll-off can vary linearly or non-linearly across the luminance roll-off region 706. In some examples, the roll-off is adjusted as a function of angle and cone density relative to the position of the fovea of the eye. The luminance levels of pixels in the luminance roll-off region 706 of the luminance-adjusted image frame 700 may be adjusted in any suitable manner as a function of angle relative to the first position 702 of fovea of the eye mapped to the image frame and based at least on a rod and cone anatomy of the eye. In the luminance-adjusted image frame 700, the digital representation of the heat signature 502 overlaid on the person 108A is positioned completely in the dimmest portion 706C of the luminance roll-off region 706.

In FIG. 8, the fovea is mapped to a second position 802 in the luminance-adjusted image frame 800. The luminance-adjusted image frame 800 includes a photopic luminance region 804 that is determined based at least on the second position 802 of the fovea. Pixels in the photopic luminance region 804 are set to native luminance levels that are not dimmed. The luminance-adjusted image frame 800 includes a luminance roll-off region 806 (e.g., including circular regions 806A, 806B, 806C). Pixels in the different circular regions 806A, 806B, 806C of the luminance roll-off region 806 have luminance levels that are reduced to different degrees. In this example, luminance levels of pixels in the first circular region 806A are adjusted lower than luminance levels of pixels in the photopic luminance region 804, luminance levels of pixels in the second circular region 806B are adjusted lower than luminance levels of pixels in the first circular region 806A, and so on.

Note that the different circular regions 806A, 806B, 806C of the luminance roll-off region 806 are presented for ease of understanding. In general, as the angular distance from the second position 802 of the fovea increases, the luminance levels of pixels are reduced to a greater degree until such luminance levels are reduced below a photopic threshold. In some examples, the roll-off can be a gradient that varies smoothly. The roll-off can vary linearly or non-linearly across the luminance roll-off region 806. The luminance levels of pixels in the luminance roll-off region 806 of the luminance-adjusted image frame 800 may be adjusted in any suitable manner as a function of angle relative to the second position 802 of fovea of the eye mapped to the image frame and based at least on a rod and cone anatomy of the eye. In the luminance-adjusted image frame 800, the digital representation of the heat signature 502 overlaid on the person 108A is positioned completely in the photopic luminance region 804, and thus the luminance levels of the pixels that make up the digital representation of the heat signature 502 are set to native luminance levels of corresponding pixels in the image frame 500 shown in FIG. 5.

In some implementations, the mixed-reality device 200 is configured to operate in a plurality of different luminance operating modes in which luminance levels of pixels of the image frame are adjusted differently based at least on a luminance operating mode selected from the plurality of different luminance operating modes to generate the luminance-adjusted image frame.

In some implementations, the mixed-reality device 200 is configured to selectively operate in a transition operating mode. The mixed-reality device 200 may operate in the transition operating mode when a user is preparing to deactivate the mixed-reality device 200 or take it off in the near future and desires to maintain dark adaptation in order to see in low-light or dark ambient lighting conditions. In the transition operating mode, the mixed-reality device 200 is configured to generate luminance-adjusted image frames that become dimmer over a window of time in order to allow the rods in the eyes of the user to become active in preparation to see in low-light or dark ambient lighting conditions. In one example, the storage subsystem 228 holds instructions executable by the logic subsystem 226 to generate a first image frame, generate a first luminance-adjusted image frame based on the first image frame, generate a second image frame, and generate a second luminance-adjusted image frame based on the second image frame. The luminance levels of the pixels of the second luminance-adjusted image frame are reduced to a greater degree than luminance levels of the pixels of the first luminance-adjusted image frame. Note that the transition of reducing the luminance levels of luminance-adjusted image frames that occurs over a window of time need not be applied to every consecutive luminance-adjusted image frame. In some examples, such reductions in luminance levels in the transition mode may occur in every other image frame, every fifth image frame, or over another number of image frames.

In some implementations, the mixed-reality device 200 is configured to selectively operate in a monocular operating mode. In such implementations, the mixed-reality device includes the left-eye display 202L and the right-eye display 202R. In the monocular operation mode, eye-tracking based foveated rendering is performed to generate luminance-adjusted image frames that are rendered for display via one of the displays and image frames that are rendered for display via the other one of the displays have luminance levels that are reduced to a greater degree. In one example, the storage subsystem 228 holds instructions executable by the logic subsystem 226 to, in the monocular operating mode, render a first luminance-adjusted image frame for display in one of the left-eye display 202L and the right-eye display 202R, generate a second luminance-adjusted image based at least on the image frame, wherein pixels in the second luminance-adjust image are reduced to a greater degree than corresponding pixels in the first luminance-adjusted image, and render the second luminance-adjusted image in the other of the left-eye display 202L and the right-eye display 202R.

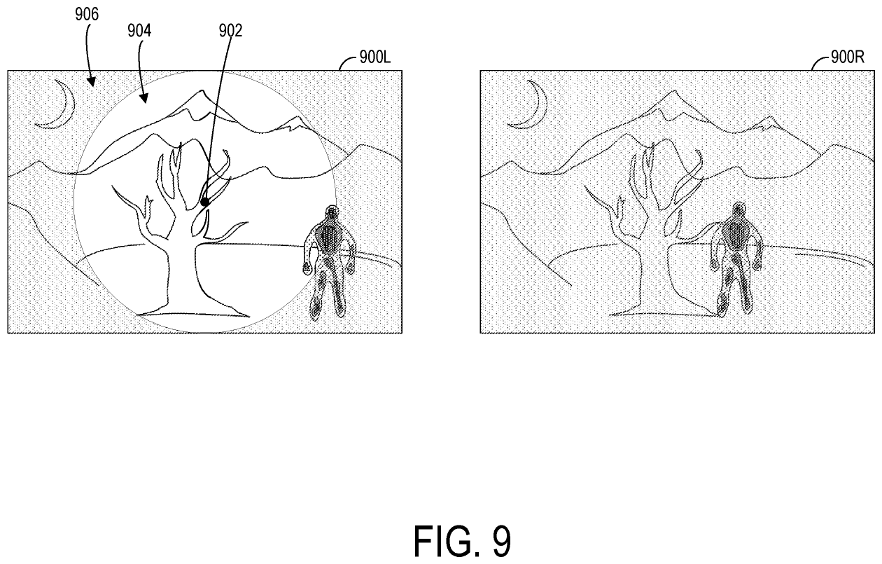

FIG. 9 shows example luminance-adjusted image frames 900L, 900R displayed via the left-eye display 202L and the right-eye display 202R of the mixed-reality device 200 while operating in the monocular operating mode. A first luminance-adjusted image frame 900L is generated based on the image frame 500 shown in FIG. 5 using eye-tracking based luminance foveated rendering for display via the left-eye display 202L. A position 902 of the fovea of the left eye of the user is mapped to the first luminance-adjusted image frame 900L. The first luminance-adjusted image frame 900L includes a photopic luminance region 904 that is determined based at least on the mapped position 902 of the fovea of the left eye of the user. Pixels in the photopic luminance region 904 are set to native luminance levels of the image frame 500 shown in FIG. 5. The first luminance-adjusted image frame 900L includes a luminance roll-off region 906 that is determined based at least on the mapped position 902 of the fovea of the left eye of the user. Pixels in the luminance roll-off region 906 are adjusted lower than the native luminance levels of corresponding pixels of the image frame 500 shown in FIG. 5.

A second luminance-adjusted image frame 900R is generated based on the image frame 500 shown in FIG. 5 for display via the right-eye display 202R. The luminance levels of pixels in the second luminance-adjusted image frame 900R are adjusted lower than corresponding pixels of the image frame 500 shown in FIG. 5. In some examples, the luminance levels of the pixels in the second luminance-adjusted image frame 900R are adjusted reduced below a photopic threshold. In some examples, the luminance levels of pixels in the second luminance-adjusted image frame 900R are reduced by a global offset. In other examples, the luminance levels of the pixels in the second luminance-adjusted image frame 900R are reduced to different luminance levels. In yet other examples, the near-eye display 202R does not display any mixed-reality image while operating in the monocular operating mode. Note that either the left-eye display 202L or the right-eye display 202R may be selected to display the luminance-adjusted image including the photopic luminance region and the luminance roll-off region while the other of the left-eye display or the right-eye display displays the dimmed image while operating in the monocular mode.

The mixed-reality device 200 may operate in the monocular operating mode to enable a user to preserve dark adaptation fully in one eye while still being able to perceive mixed-reality imagery in the other eye in a manner that also preserves dark adaptation in that eye.

In some implementations, the mixed-reality device 200 may be configured to switch between luminance operating modes based on user input. In some implementations, the mixed-reality device 200 includes an input subsystem 230 configured to receive user input indicating a luminance operating mode selected from the plurality of luminance operating modes of the mixed-reality device 200. The storage subsystem 228 holds instructions executable by the logic subsystem 226 to adjust luminance levels of pixels of the luminance-adjusted image frame further based at least on the selected luminance operating mode to generate the luminance-adjusted image frame.

In other implementations, the mixed-reality device 200 may be configured to automatically switch between different luminance operation modes based on various parameters that are used to infer current operating conditions of the mixed-reality device, such as automatically adjusting luminance roll-off rates based on ambient lighting conditions and/or forecasted ambient lighting conditions (e.g., inferred from weather reports, GPS location, and/or other parameters).

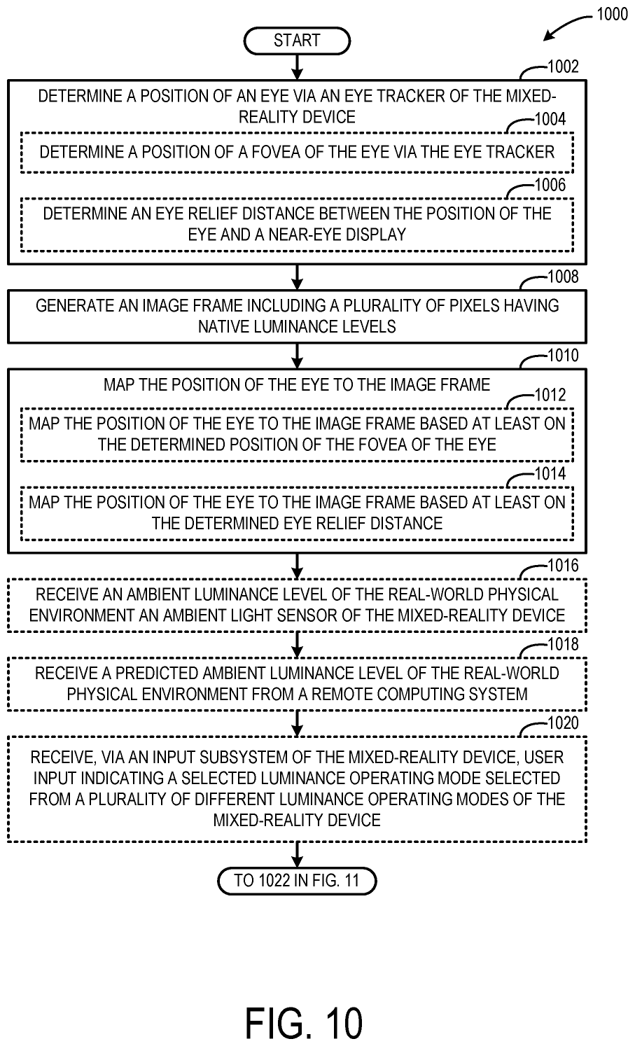

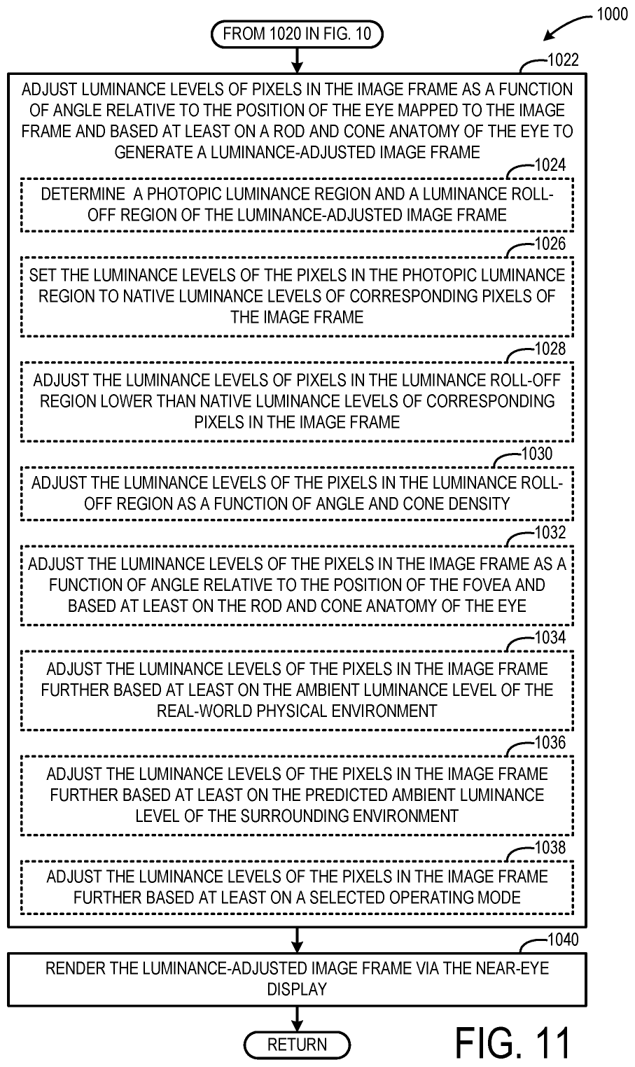

FIGS. 10-11 show an example method 1000 for controlling a mixed-reality device. For example, the method 1000 may be performed by the mixed-reality device 100 shown in FIG. 1 and the mixed-reality device 200 shown in FIG. 2.

In FIG. 10, at 1002, the method 1000 includes determining a position of an eye via an eye tracker of the mixed-reality device. In some implementations, at 1004, the method 1000 may include determining a position of a fovea of the eye via the eye tracker. In some implementations, at 1006, the method 1000 may include determining an eye relief distance between the position of the eye and a near-eye display of the mixed-reality device.

At 1008, the method 1000 includes generating an image frame including a plurality of pixels. Each of the pixels in the image frame has a native luminance level.

At 1010, the method 1000 includes mapping the position of the eye to the image frame. In some implementations, at 1012, the method 1000 may include mapping the position of the eye to the image frame based at least on the determined position of the fovea of the eye. In some implementations, at 1014, the method 1000 may include mapping the position of the eye to the image frame based at least on the determined eye relief distance between the position of the eye and the near-eye display.

In some implementations, at 1016, the method 1000 may include receiving an ambient luminance level of the real-world physical environment from an ambient light sensor of the mixed-reality device.

In some implementations, at 1018, the method 1000 may include receiving a predicted ambient luminance level of the real-world physical environment from a remote computing system in communication with the mixed-reality device.

In some implementations, at 1020, the method 1000 may include receiving, via an input subsystem of the mixed-reality device, user input indicating a selected luminance operating mode selected from a plurality of different luminance operating modes of the mixed-reality device.

In FIG. 11, at 1022, the method 1000 includes adjusting luminance levels of pixels of the image frame as a function of angle relative to the position of the eye mapped to the image frame and based at least on a rod and cone anatomy of the eye to generate a luminance-adjusted image frame. In some implementations, at 1024, generating the luminance-adjusted image frame may include determining a photopic luminance region of pixels and a luminance roll-off region of pixels in the luminance-adjusted image frame based at least on the position of the fovea of the eye. In some implementations, at 1026, generating the luminance-adjusted image frame may include setting the luminance levels of the pixels in the photopic luminance region to native luminance levels of corresponding pixels in the image frame. In some implementations, at 1028, generating the luminance-adjusted image frame may include adjusting luminance levels of pixels in the luminance roll-off region lower than native luminance levels of corresponding pixels in the image frame. In some implementations, at 1030, generating the luminance-adjusted image frame may include adjusting the luminance levels of the pixels in the luminance roll-off region as a function of angle and cone density relative to the position of the fovea of the eye mapped to the image frame. In some implementations, at 1032, generating the luminance-adjusted image frame may include adjusting the luminance levels of the pixels in the image frame as a function of angle relative to the position of the fovea of the eye mapped to the image frame based at least on the rod and cone anatomy of the eye. In some implementations, at 1034, generating the luminance-adjusted image frame may include adjusting the luminance levels of the pixels in the image frame further based at least on the ambient luminance level of the real-world physical environment received from the ambient light sensor of the mixed-reality device. In some implementations, at 1036, generating the luminance-adjusted image frame may include adjusting the luminance levels of the pixels in the image frame further based at least on the predicted ambient luminance level of the real-world physical environment received from the remote computing system. In some implementations, at 1038, generating the luminance-adjusted image frame may include adjusting the luminance levels of the pixels in the image frame further based at least on a selected operating mode of the mixed-reality device.

At 1040, the method 1000 includes rendering the luminance-adjusted image frame via the near-eye display of the mixed-reality device.

The method 1000 may be performed repeatedly as the position of the eye is updated via the eye tracker to allow the user to view mixed-reality images with visual acuity while maintaining dark adaptation for seeing in low-light or dark ambient lighting conditions. Moreover, in some examples, the method 1000 may be performed on a per-eye basis.

The methods and processes described herein may be tied to a computing system of one or more computing devices. In particular, such methods and processes may be implemented as an executable computer-application program, a network-accessible computing service, an application-programming interface (API), a library, or a combination of the above and/or other compute resources.

FIG. 12 schematically shows a simplified representation of a computing system 1200 configured to provide any to all of the compute functionality described herein. For example, the computing system 1200 may correspond to the mixed-reality device 100 shown in FIG. 1 and the mixed-reality device 200 shown in FIG. 2. Computing system 1200 may take the form of one or more personal computers, network-accessible server computers, tablet computers, home-entertainment computers, gaming devices, mobile computing devices, mobile communication devices (e.g., smart phone), virtual/augmented/mixed-reality computing devices, wearable computing devices, Internet of Things (IoT) devices, embedded computing devices, and/or other computing devices.

Computing system 1200 includes a logic subsystem 1202 and a storage subsystem 1204. Computing system 1200 may optionally include a display subsystem 1206, input subsystem 1208, communication subsystem 1210, and/or other subsystems not shown in FIG. 12.

Logic subsystem 1202 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 1204 includes one or more physical devices configured to temporarily and/or permanently hold computer information such as data and instructions executable by the logic subsystem. When the storage subsystem includes two or more devices, the devices may be collocated and/or remotely located. Storage subsystem 1204 may include volatile, nonvolatile, dynamic, static, read/write, read-only, random-access, sequential-access, location-addressable, file-addressable, and/or content-addressable devices. Storage subsystem 1204 may include removable and/or built-in devices. When the logic subsystem executes instructions, the state of storage subsystem 1204 may be transformed—e.g., to hold different data.

Aspects of logic subsystem 1202 and storage subsystem 1204 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

When included, display subsystem 1206 may be used to present a visual representation of data held by storage subsystem 1204. This visual representation may take the form of a graphical user interface (GUI). Display subsystem 1206 may include one or more display devices utilizing virtually any type of technology. In some implementations, display subsystem may include one or more virtual-, augmented-, or mixed-reality displays.

When included, input subsystem 1208 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 1210 may be configured to communicatively couple computing system 1200 with one or more other computing devices. Communication subsystem 1210 may include wired and/or wireless communication devices compatible with one or more different communication protocols. The communication subsystem may be configured for communication via personal-, local- and/or wide-area networks.

In an example, a mixed-reality device comprises an eye tracker configured to determine a position of an eye, a near-eye display, a logic subsystem, and a storage subsystem holding instructions executable by the logic subsystem to generate an image frame including a plurality of pixels, wherein each pixel has a native luminance level, map the position of the eye to the image frame, adjust luminance levels of pixels of the image frame as a function of angle relative to the position of the eye mapped to the image frame and based at least on a rod and cone anatomy of the eye to generate a luminance-adjusted image frame, and render, via the near-eye display, the luminance-adjusted image frame. In this example and/or other examples, the storage subsystem may hold instructions executable by the logic subsystem to determine, via the eye tracker, a position of a fovea of the eye, and adjust the luminance levels of the pixels of the image frame as a function of angle relative to the position of the fovea of the eye mapped to the image frame and based at least on the rod and cone anatomy of the eye to generate the luminance-adjusted image frame. In this example and/or other examples, the storage subsystem may hold instructions executable by the logic subsystem to determine a photopic luminance region of pixels of the luminance-adjusted image frame and a luminance roll-off region of pixels of the luminance-adjusted image frame based at least on the position of the fovea of the eye, set luminance levels of pixels in the photopic luminance region to the native luminance levels of corresponding pixels in the image frame, and adjust luminance levels of pixels in the luminance roll-off region lower than the native luminance levels of corresponding pixels of the image frame. In this example and/or other examples, the luminance levels of the pixels in the luminance roll-off region may be adjusted as a function of angle and cone density relative to the position of the fovea. In this example and/or other examples, the storage subsystem may hold instructions executable by the logic subsystem to determine, via the eye tracker, an eye relief distance between the position of the eye and the near-eye display, and map the position of the eye to the image frame based at least on the eye relief distance. In this example and/or other examples, the mixed-reality device may further comprise an ambient light sensor configured to determine an ambient luminance level of a surrounding environment; and the storage subsystem may hold instructions executable by the logic subsystem to adjust the luminance levels of the pixels of the image frame further based at least on the ambient luminance level of the surrounding environment to generate the luminance-adjusted image frame. In this example and/or other examples, the mixed-reality device may further comprise a communication subsystem configured to receive a predicted ambient luminance level of the surrounding environment from a remote computing system, and the storage subsystem may hold instructions executable by the logic subsystem to adjust the luminance levels of the pixels of the image frame further based at least on the predicted ambient luminance level of the surrounding environment to generate the luminance-adjusted image frame. In this example and/or other examples, the mixed-reality device may be configured to operate in a plurality of different luminance operating modes in which luminance levels of pixels of the image frame are adjusted differently based at least on a luminance operation mode selected from the plurality of different luminance operating modes to generate the luminance-adjusted image frame. In this example and/or other examples, the mixed-reality device may further comprise an input subsystem configured to receive user input indicating a luminance operating mode selected from the plurality of luminance operating modes of the mixed-reality device and the storage subsystem may hold instructions executable by the logic subsystem to adjust luminance levels of pixels of the image frame further based at least on the selected luminance operating mode to generate the luminance-adjusted image frame. In this example and/or other examples, the plurality of different luminance operating modes may include a transition operating mode, the luminance-adjusted image frame may be a first luminance-adjusted image frame, and the storage subsystem may hold instructions executable by the logic subsystem to in the transition operating mode, generate a second image frame including a plurality of pixels, wherein each pixel has a native luminance level, adjust luminance levels of pixels of the second image frame as a function of angle relative to the position of the eye mapped to the image frame and based at least on a rod and cone anatomy of the eye to generate a second luminance-adjusted image frame, luminance levels of the pixels of the second luminance-adjusted image frame may be less than luminance levels of the pixels of the first luminance-adjusted image frame, and render, via the near-eye display, the second luminance-adjusted image frame. In this example and/or other examples, the near-eye display may include a left-eye display and a right-eye display, the plurality of different luminance operating modes may include a monocular operating mode, the luminance-adjusted image may be a first luminance-adjusted image and the storage subsystem may hold instructions executable by the logic subsystem to in the monocular operating mode, render the first luminance-adjusted image frame for display in one of the left-eye display and the right-eye display, generate a second luminance-adjusted image based at least on the image frame, pixels in the second luminance-adjust image may be reduced to a greater degree than corresponding pixels in the first luminance-adjusted image, and render the second luminance-adjusted image in the other of the left-eye display and the right-eye display.

In another example, a method for controlling a mixed-reality device comprises determining, via an eye tracker of the mixed-reality device, a position of an eye, generating an image frame including a plurality of pixels, wherein each pixel has a native luminance level, mapping the position of the eye to the image frame, adjusting luminance levels of pixels of the image frame as a function of angle relative to the position of the eye mapped to the image frame and based at least on a rod and cone anatomy of the eye to generate a luminance-adjusted image frame, and render, via a near-eye display of the mixed-reality device, the luminance-adjusted image frame. In this example and/or other examples, the method may further comprise determining, via the eye tracker, a position of a fovea of the eye, and adjust the luminance levels of the pixels of the image frame as a function of angle relative to the position of the fovea of the eye mapped to the image frame and based at least on the rod and cone anatomy of the eye to generate the luminance-adjusted image frame. In this example and/or other examples, the method may further comprise determining a photopic luminance region of pixels of the luminance-adjusted image frame and a luminance roll-off region of pixels of the luminance-adjusted image frame based at least on the position of the fovea of the eye, setting luminance levels of pixels in the photopic luminance region to the native luminance levels of corresponding pixels in the image frame, and adjusting luminance levels of pixels in the luminance roll-off region lower than the native luminance levels of corresponding pixels of the image frame. In this example and/or other examples, the method may further comprise determining, via the eye tracker, an eye relief distance between the position of the eye and the near-eye display, and mapping the position of the eye to the image frame based at least on the eye relief distance. In this example and/or other examples, the method may further comprise determining, via an ambient light sensor of the mixed-reality device, an ambient luminance level of a surrounding environment, and adjusting the luminance levels of the pixels of the image frame further based at least on the ambient luminance level of the surrounding environment to generate the luminance-adjusted image frame. In this example and/or other examples, the method may further comprise receiving, via a communication subsystem of the mixed-reality device, a predicted ambient luminance level of the surrounding environment from a remote computing system, and adjust the luminance levels of the pixels of the image frame further based at least on the predicted ambient luminance level of the surrounding environment to generate the luminance-adjusted image frame. In this example and/or other examples, the mixed-reality device may be configured to operate in a plurality of different luminance operating modes in which luminance levels of pixels of the image frame are adjusted differently based at least on a luminance operation mode selected from the plurality of different luminance operating modes to generate the luminance-adjusted image frame. In this example and/or other examples, the method may further comprise receiving, via an input subsystem of the mixed-reality device, user input indicating a luminance operating mode selected from the plurality of luminance operating modes of the mixed-reality device, and the near-eye display may be configured to adjust luminance levels of pixels of the image frame further based at least on the selected luminance operating mode to generate the luminance-adjusted image frame.

In yet another example, a mixed-reality device comprises an eye tracker configured to determine a position of a fovea of an eye, and a near-eye display configured to generate an image frame including a plurality of pixels, wherein each pixel has a native luminance level, map the position of the fovea of the eye to an image frame, determine a photopic luminance region of pixels and a luminance roll-off region of pixels of the image frame based at least on the position of the fovea of the eye, set luminance levels of pixels in the photopic luminance region to native luminance levels of the image frame, and adjust luminance levels of pixels in the luminance roll-off region as a function of angle and cone density relative to the position of the fovea to generate a luminance-adjusted image frame, and render the luminance-adjusted image frame for display to the eye.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A mixed-reality device comprising:
an eye tracker configured to determine a position of an eye;
a near-eye display;
a logic subsystem; and
a storage subsystem holding instructions executable by the logic subsystem to:
generate an image frame including a plurality of pixels, wherein each pixel has a native luminance level;
map the position of the eye to the image frame,
adjust luminance levels of pixels of the image frame as a function of angle relative to the position of the eye mapped to the image frame and based at least on a rod and cone anatomy of the eye to generate a luminance-adjusted image frame, and
render, via the near-eye display, the luminance-adjusted image frame.

2. The mixed-reality device of claim 1, wherein the storage subsystem holds instructions executable by the logic subsystem to:
determine, via the eye tracker, a position of a fovea of the eye, and
adjust the luminance levels of the pixels of the image frame as a function of angle relative to the position of the fovea of the eye mapped to the image frame and based at least on the rod and cone anatomy of the eye to generate the luminance-adjusted image frame.

3. The mixed-reality device of claim 2, wherein the storage subsystem holds instructions executable by the logic subsystem to:
determine a photopic luminance region of pixels of the luminance-adjusted image frame and a luminance roll-off region of pixels of the luminance-adjusted image frame based at least on the position of the fovea of the eye,
set luminance levels of pixels in the photopic luminance region to the native luminance levels of corresponding pixels in the image frame, and
adjust luminance levels of pixels in the luminance roll-off region lower than the native luminance levels of corresponding pixels of the image frame.

4. The mixed-reality device of claim 3, wherein the luminance levels of the pixels in the luminance roll-off region are adjusted as a function of angle and cone density relative to the position of the fovea.

5. The mixed-reality device of claim 1, wherein the storage subsystem holds instructions executable by the logic subsystem to:
determine, via the eye tracker, an eye relief distance between the position of the eye and the near-eye display, and
map the position of the eye to the image frame based at least on the eye relief distance.

6. The mixed-reality device of claim 1, further comprising:
an ambient light sensor configured to determine an ambient luminance level of a surrounding environment; and
wherein the storage subsystem holds instructions executable by the logic subsystem to:
adjust the luminance levels of the pixels of the image frame further based at least on the ambient luminance level of the surrounding environment to generate the luminance-adjusted image frame.

7. The mixed-reality device of claim 1, further comprising:
a communication subsystem configured to receive a predicted ambient luminance level of the surrounding environment from a remote computing system; and
wherein the storage subsystem holds instructions executable by the logic subsystem to:
adjust the luminance levels of the pixels of the image frame further based at least on the predicted ambient luminance level of the surrounding environment to generate the luminance-adjusted image frame.

8. The mixed-reality device of claim 1, wherein the mixed-reality device is configured to operate in a plurality of different luminance operating modes in which luminance levels of pixels of the image frame are adjusted differently based at least on a luminance operation mode selected from the plurality of different luminance operating modes to generate the luminance-adjusted image frame.

9. The mixed-reality device of claim 8, further comprising:
an input subsystem configured to receive user input indicating a luminance operating mode selected from the plurality of luminance operating modes of the mixed-reality device; and wherein the storage subsystem holds instructions executable by the logic subsystem to:
adjust luminance levels of pixels of the image frame further based at least on the selected luminance operating mode to generate the luminance-adjusted image frame.

10. The mixed-reality device of claim 8, wherein the plurality of different luminance operating modes includes a transition operating mode, wherein the luminance-adjusted image frame is a first luminance-adjusted image frame, and wherein the storage subsystem holds instructions executable by the logic subsystem to:
in the transition operating mode,
generate a second image frame including a plurality of pixels, wherein each pixel has a native luminance level;
adjust luminance levels of pixels of the second image frame as a function of angle relative to the position of the eye mapped to the image frame and based at least on a rod and cone anatomy of the eye to generate a second luminance-adjusted image frame, wherein luminance levels of the pixels of the second luminance-adjusted image frame are less than luminance levels of the pixels of the first luminance-adjusted image frame; and
render, via the near-eye display, the second luminance-adjusted image frame.

11. The mixed-reality device of claim 8, wherein the near-eye display includes a left-eye display and a right-eye display, wherein the plurality of different luminance operating modes includes a monocular operating mode, wherein the luminance-adjusted image is a first luminance-adjusted image and wherein the storage subsystem holds instructions executable by the logic subsystem to:
in the monocular operating mode, render the first luminance-adjusted image frame for display in one of the left-eye display and the right-eye display;
generate a second luminance-adjusted image based at least on the image frame, wherein pixels in the second luminance-adjust image are reduced to a greater degree than corresponding pixels in the first luminance-adjusted image; and
render the second luminance-adjusted image in the other of the left-eye display and the right-eye display.

12. A method for controlling a mixed-reality device, the method comprising:
determining, via an eye tracker of the mixed-reality device, a position of an eye;
generating an image frame including a plurality of pixels, wherein each pixel has a native luminance level;
mapping the position of the eye to the image frame;
adjusting luminance levels of pixels of the image frame as a function of angle relative to the position of the eye mapped to the image frame and based at least on a rod and cone anatomy of the eye to generate a luminance-adjusted image frame, and
render, via a near-eye display of the mixed-reality device, the luminance-adjusted image frame.

13. The method of claim 12, further comprising
determining, via the eye tracker, a position of a fovea of the eye; and
adjust the luminance levels of the pixels of the image frame as a function of angle relative to the position of the fovea of the eye mapped to the image frame and based at least on the rod and cone anatomy of the eye to generate the luminance-adjusted image frame.

14. The method of claim 12, further comprising:
determining a photopic luminance region of pixels of the luminance-adjusted image frame and a luminance roll-off region of pixels of the luminance-adjusted image frame based at least on the position of the fovea of the eye;
setting luminance levels of pixels in the photopic luminance region to the native luminance levels of corresponding pixels in the image frame; and
adjusting luminance levels of pixels in the luminance roll-off region lower than the native luminance levels of corresponding pixels of the image frame.

15. The method of claim 12, further comprising:
determining, via the eye tracker, an eye relief distance between the position of the eye and the near-eye display; and
mapping the position of the eye to the image frame based at least on the eye relief distance.

16. The method of claim 12, further comprising:
determining, via an ambient light sensor of the mixed-reality device, an ambient luminance level of a surrounding environment; and
adjusting the luminance levels of the pixels of the image frame further based at least on the ambient luminance level of the surrounding environment to generate the luminance-adjusted image frame.

17. The method of claim 12, further comprising:
receiving, via a communication subsystem of the mixed-reality device, a predicted ambient luminance level of the surrounding environment from a remote computing system; and
adjust the luminance levels of the pixels of the image frame further based at least on the predicted ambient luminance level of the surrounding environment to generate the luminance-adjusted image frame.

18. The method of claim 12, wherein the mixed-reality device is configured to operate in a plurality of different luminance operating modes in which luminance levels of pixels of the image frame are adjusted differently based at least on a luminance operation mode selected from the plurality of different luminance operating modes to generate the luminance-adjusted image frame.

19. The method of claim 18, further comprising:
receiving, via an input subsystem of the mixed-reality device, user input indicating a luminance operating mode selected from the plurality of luminance operating modes of the mixed-reality device; and
wherein the near-eye display is configured to adjust luminance levels of pixels of the image frame further based at least on the selected luminance operating mode to generate the luminance-adjusted image frame.

20. A mixed-reality device comprising:
an eye tracker configured to determine a position of a fovea of an eye; and
a near-eye display configured to:
generate an image frame including a plurality of pixels, wherein each pixel has a native luminance level;
map the position of the fovea of the eye to an image frame,
determine a photopic luminance region of pixels and a luminance roll-off region of pixels of the image frame based at least on the position of the fovea of the eye,
set luminance levels of pixels in the photopic luminance region to native luminance levels of the image frame, and adjust luminance levels of pixels in the luminance roll-off region as a function of angle and cone density relative to the position of the fovea to generate a luminance-adjusted image frame; and
render the luminance-adjusted image frame for display to the eye.
